(19) United States
(12) Patent Application Publication
(10) Pub. No.: US 2016/0330905 A1
(43) Pub. Date: Nov. 17, 2016

(54) Mowing Machine

(71) Applicant: Maschinenfabrik Bernard Krone GmbH & Co. KG, Spelle (DE)

(72) Inventors: Josef Horstmann, Ibbenbüren (DE); Andreas Afting, Emsbüren (DE); Jens Lömker, Hopsten (DE)

(21) Appl. No.: 15/151,514

(22) Filed: May 11, 2016

(30) Foreign Application Priority Data
May 15, 2015 (DE) 10 2015 006 065.1

(51) Int. Cl. A01D 34/82; A01D 34/66

(52) U.S. Cl. CPC A01D 34/82; A01D 34/66; A01D 2101/00

(57) ABSTRACT

A mowing machine has a frame component group; a mower component group connected to the frame component group so as to be supported by it on the field in a working and operating position; and a protection and cover component group surrounding the mower component group. The mower component group has rotatingly driven cutting members. The cutting members are arranged transverse to a traveling and working direction of the mowing machine and have a rotation body that, in the working and operating position, is close to the ground and has cutting blades at the outer periphery. An active suction unit correlated with the mower component group deflects an air flow, oriented from the mower component group in a first direction toward the still standing crop, in a second direction in which the crop is no longer loaded by the air flow.

### BACKGROUND OF THE INVENTION

The invention relates to a mowing machine for mowing agricultural stem and leaf crop. The mowing machine comprises at least two cutting members that are driven in rotation about an approximately vertically oriented axis, wherein the cutting members comprise at least one rotation body which, in the working and operating position, is positioned close to the ground and is provided at its outer periphery with at least two cutting blades. The cutting members are supported approximately transverse to the traveling and working direction on a mower component group, wherein the mower component group in the working and operating position is supported by means of a frame component group on the ground and is at least partially surrounded by a protection and cover component group.

Such mowing machines are known in various embodiments in the prior art and serve to cut agricultural stem and leaf crop standing on a field or meadow in order to subsequently lay it in a swath required for the further harvesting process or in a uniform layer across the entire working width for improving the drying process of the crop. For this purpose, the mowing machine is provided with cutting members which are driven in rotation at a high circumferential speed about an approximately vertical axis. In this context, at least two cutting blades correlated with the cutting members cut the grass or similar stem or leaf crop and convey it in a direction which is opposite to the traveling and working direction so that the crop either is laid behind the cutting members in a swath or, prior to being laid, is passing through a processing device in order to accelerate the drying process.

In practical use of such mowing machines it has however been found that conditions of use are encountered in which the cutting members cannot cut properly the stem or leaf crop so that strips remain standing on the field or meadow in which the stem or leaf crop has been cut insufficiently. Practical tests in regard to this problem have shown that, for a paired adjustment of the rotational drive direction of the cutting members, the cutting members whose rotational direction is oriented in the traveling and working direction generate an air flow which, during the mowing process, pushes the stem or leaf crop away from the cutting members and thereby significantly impairs an optimal mowing process. This problem is even more exacerbated in that the cutting members are rotating at a high circumferential speed during the mowing process.

DE 201 08 505 U1 discloses a rotary mower in which mowing discs supported on a machine frame are used for the mowing process. For solving the problem in regard to the air flow that is oriented in the traveling and working direction, it is proposed to connect to the bottom side of the mowing discs air conveying elements that are designed such that a radial inwardly oriented air flow is produced and the resulting air flow can pass through passages in the mowing disc from the bottom side of the mowing disc to its top side. However, this does not yet eliminate the problem of an air flow that is directed onto the still standing stem or leaf crop during mowing operation because the mowing discs are capable of generating an air flow also at their top side.

It is therefore an object of the invention to provide a mowing machine for mowing agricultural stem or leaf crop in which the known problems of the prior art are reliably prevented and, as a result, a clean cutting pattern can be achieved under the numerous different conditions of use.

### SUMMARY OF THE INVENTION

In accordance with the invention, this is achieved in that the mower component group has correlated therewith an active suction unit, which is configured to deflect an air flow, which is oriented from the mower component group in a first direction toward the still standing stem and leaf crop, in a second direction in which the still standing stem and leaf crop is no longer loaded by the air flow. The features of the dependent claims provide further advantageous developments.

According to the invention, a mowing machine for mowing agricultural stem or leaf crop is proposed that comprises at least two cutting members which are driven in rotation about a substantially vertically oriented axis, wherein the cutting members comprise at least one rotation body which, in the working and operating position, is positioned close to the ground and is provided at its outer periphery with at least two cutting blades, wherein the cutting members are supported approximately transversely to the traveling and working direction on a mower component group, wherein the mower component group in the working and operating position is supported by means of a frame component group on the ground and is surrounded at least partially by a protection and cover component group, wherein the mower component group has correlated therewith an active suction unit which is configured to deflect an air flow, which is oriented from the mower component group in the first direction toward the still standing stem and leaf crop, in a second direction in which the still standing stem and leaf crop is no longer loaded by the air flow.

The invention thus proposes a mowing machine for mowing agricultural stem or leaf crop, wherein an active suction unit is correlated with the mower component group. This suction or vacuum unit is configured to deflect the air flows, which are prevailing below a protection and cover component group that at least partially surrounds the mower component group and are directed in the first direction toward the stem or leaf crop to be mowed, in a second direction in which the stem or leaf crop is no longer loaded by the air flow. This deflection of the air flow in accordance with the invention advantageously causes the stem or leaf crop that is to be mowed to no longer be pushed away or pushed over in the traveling or working direction during the mowing process. When mowing the agricultural stem or leaf crop with such a harvesting process, the field or meadow after mowing exhibits stubble of uniform length across the field or meadow.

The deflection of the air flow in this context is produced in that the suction or vacuum unit which is correlated with the mower component group sucks away a sufficiently large air quantity from an area which is extending above the cutting members that are formed as rotation bodies and which is extending up to the protection and cover component group that at least partially surrounds the mower component group.

For safety reasons, the use of mowing machines in which the cutting action is generated by free cutting performed by a plurality of cutting members that are rotating at high circumferential speeds and are provided with radially outwardly projecting cutting blades, mandatorily requires that the mower component group with the cutting members driven in rotation is surrounded at least at the topside by a protection and cover component group. This may be an approximately box-shaped sheet metal cover and/or an apron arrangement which provides a satisfactory protective action against possibly flying rocks or similar foreign members during the mowing process but also creates an area around the mower component group from which airflows, generated for example by the cutting members driven in rotation, cannot be discharged without suitable technical means being provided.

The suction or vacuum unit according to the invention constitutes such a technical means which is correlated with the mower component group and is suitable for use in a mowing machine with cutting members in the form of mowing discs supported close to the ground on a mowing beam as well as for use on a so-called rotary or drum mower. By the action of the suction or vacuum unit according to the invention, the air flows, which are caused for example by the rotatingly driven cutting members or by a processing unit which is arranged downstream of the cutting members, can be deflected and discharged directly into an area which is outside of the protection and cover component group. In a further advantageous embodiment, it can also be provided that the air flow which is discharged from the surrounding area of the mower component group is directed into an area downstream of a processing device comprising at least one processing roller in order to improve here for example the laying action of the stem or leaf crop after the harvesting step.

An advantageous embodiment of the invention is based on the concept of a suction or vacuum unit according to the invention being correlated with at least one of the cutting members of the mower component group. For this purpose, it is provided that above a rotation body of the cutting member that is close to the ground (ground surface) a conveying and guiding drum for mowed stem or leaf crop is provided. By use of such a conveying and guiding drum it is then made possible that above the conveying and guiding drum a suction or vacuum device, designed as a fan unit or blower unit with radial flow direction, can be arranged. Advantageously, the drive energy of the cutting members which are driven at high circumferential speed is thus utilized in order to suck away a sufficiently large air quantity from the surrounding area of the mower component group so that in this way a reliable deflection of the air flows which are directed onto the still to be mowed stem and leaf crop is achieved. The suction action of a sufficiently large air quantity from the surrounding area of the cutting members of the mower component group has a decisive effect on the flow level and pressure level in the area that is located below the protection and cover component group and that is considered to be relatively tightly partitioned off so that in this way an effective deflection of the disadvantageous air flows is generated.

In order to be able to suck away a sufficiently large air quantity from the surrounding area of the mower component group, it may be necessary to correlate a suction or vacuum unit, embodied as a fan or blower unit with radial flow direction, with at least one cutting member or even several cutting members. Moreover, it can be provided in this context that the air quantity to be conveyed by the suction or vacuum unit that is embodied as a fan or blower unit is adjustable. Constructively, a suction or vacuum unit which is embodied as a fan or blower unit with radial flow direction and is correlated with at least one cutting member can be designed such that a fan or blower rotor which is provided with conveying elements is connected to the top side of the conveying and guiding drum of one or several cutting members and is surrounded by a fan or blower housing. The fan or blower housing is secured in this respect preferably on a frame component group or on the protection and cover component group of the mowing machine.

According to the preceding explanations, the invention has been described in connection with a suction or vacuum unit embodied as a fan or blower unit with radial flow direction. The invention is however not limited in any way to such a type of fan and blower units. Instead, the invention can also be used in connection with a fan or blower unit with axial flow direction.

Furthermore, it may also be possible that a further possible embodiment of a fan or blower unit comprises a fan or blower rotor which is extending with its longitudinal (length) extension horizontally and transversely to the traveling and working direction and which, with regard to its length extension, extends across several cutting members of the mower component group. In this context, a more uniform suction action of a sufficiently large air quantity from the surrounding area of the mower component group can be provided with regard to the entire mowing width of the mowing machine.

In the context of a further development of the invention, it can be provided that one or several processing rollers of a processing device which is arranged downstream of the cutting members is at least partially enclosed by a baffle plate. The baffle plate is designed such that the air flows which are introduced by the one or several processing rollers are reversed and in this way, according to the Venturi principle, a sufficiently large air quantity can be removed by suction from the surrounding area of the mower component group.

Moreover, it is also conceivable that on a mowing machine for mowing agricultural stem or leaf crop comprising at least two cutting members which are driven in rotation about a substantially vertically oriented axis, wherein the cutting members comprise at least one rotation body which, in the working and operating position, is positioned close to the ground and is provided at its outer periphery with at least two cutting blades, wherein the cutting members are supported approximately transversely to the traveling and working direction on a mower component group, wherein the mower component group in the working and operating position is supported by means of a frame component group on the ground and is surrounded at least partially by a protection and cover component group, a processing device is arranged downstream of the mower component group in relation to the traveling and working direction and at least one of the processing rollers of the processing device is enclosed at least partially by a cover plate.

From practical experience, it is known that the processing rollers of a processing device during harvesting operation also cause air flows which are directed toward the stem and leaf crop to be mowed and thus also have an effect on the cutting quality. Constructively, the cover plates correlated with the processing rollers are designed such that the processing rollers convey less air. This means that the cover plates must be arranged so as to be positioned as close as possible to the surface of the processing rollers in order to be able to perform their function. Moreover, it is provided that the cover plates are correlated with the processing rollers such that movements of the processing rollers in the direction of height, which occur as a result of the crop stream having different thickness, can be carried out by the cover plates synchronous with the processing rollers.

In the following, an advantageous embodiment of the invention will be explained with the aid of the drawings.

### BRIEF DESCRIPTION OF THE DRAWING

FIG. 1 shows a perspective view of a mowing machine according to the invention in which the machine side which is pointing in the traveling and working direction is shown partially broken away.

FIG. 2 is a schematic illustration of a mower component group of the mowing machine according to FIG. 1 in which an overview of various air flows is illustrated.

FIG. 3 is an enlarged broken-off perspective view of the mowing machine according to FIG. 1.

FIG. 4 is a side view of the mowing machine according to FIG. 1 in which the cutting member to the left in traveling and working direction is shown in a section view.

### DESCRIPTION OF PREFERRED EMBODIMENTS

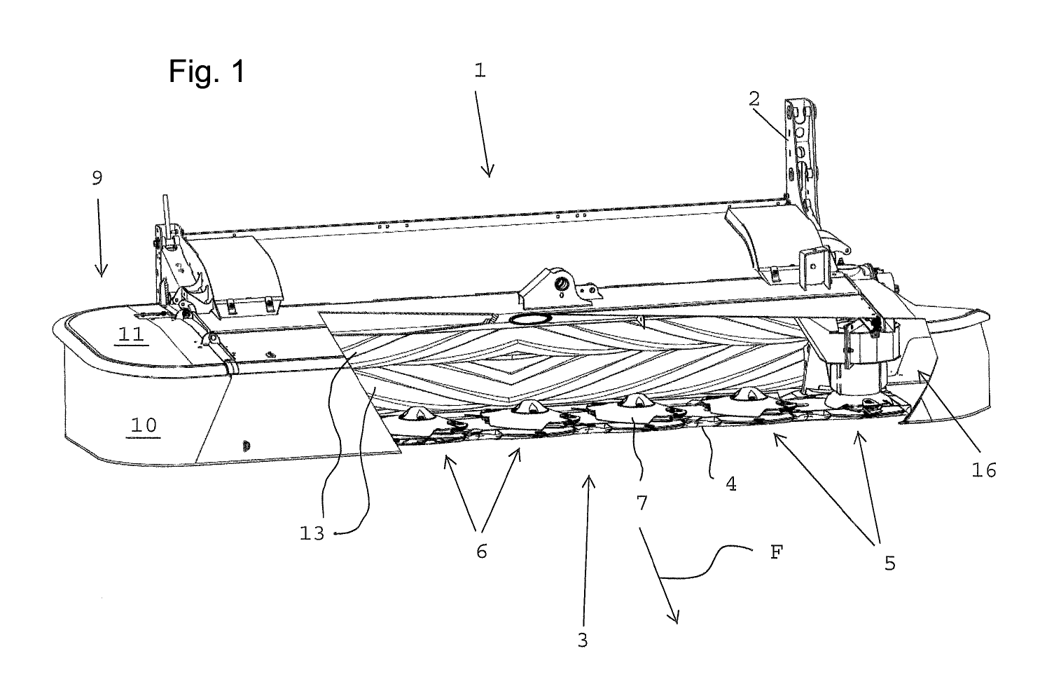

FIG. 1 illustrates a mowing machine 1 for mowing agricultural stem or leaf crop which can be mounted by means of a frame component group 2 for example to a three-point lifting device of an agricultural tractor or a similar support vehicle. In further embodiments, the mowing machine 1 can be connected by means of the frame component group 2 to a carriage and can thus be moved with the carriage across the ground surface of the field or meadow to be mowed. During mowing, the mowing machine is guided in traveling and working direction F across the ground surface of the field or meadow wherein a portion of the machine weight is supported on the ground while the further portion of the machine weight is absorbed by means of a controlled ground pressure relief action by the frame component group 2 or the downstream machine components such as three-point lifting devices or chassis.

As can be seen also in FIG. 1, the mowing machine 1 comprises a mower component group 3 which is comprised of cutting members 5 that are supported in an arrangement transverse to the traveling and working direction F on a mowing beam 4. The cutting members 5 comprise rotation bodies 6 arranged close to the ground which have the shape of a mowing disc 7 and are provided at their outer periphery with two oppositely arranged cutting blades 8.

In a further embodiment, the invention can however also be embodied with a mower component group in which the cutting members are so-called mowing drums wherein the cutting members are supported at the side facing away from the ground on a drive beam of the frame component group 2.

FIG. 1 also illustrates that the mower component group 3 is surrounded by a protection and cover component group 9 which here is substantially designed as a protective apron arrangement 10 and as a protective hood 11; parts of a housing which is surrounding a processing device 12 with two processing rollers 13 that are arranged above one another is incorporated into the protective hood 11. During the harvesting operation, the rotatingly driven processing rollers 13 of the processing device 12 pick up the stem or leaf crop that has been mowed by the cutting members 5, squeeze it, and then lay it subsequently onto the field or meadow. With this measure, the drying process is significantly accelerated.

With respect to the protection and cover component group 9 surrounding the mower component group 3, the illustration of FIG. 1 shows very clearly that the surrounding area of the mower component group 3 during harvesting operation in respect to discharging of undesirable airflows represents a relatively tightly closed-off area so that without suitable technical means a discharge or deflection of undesirable air flows is hardly possible.

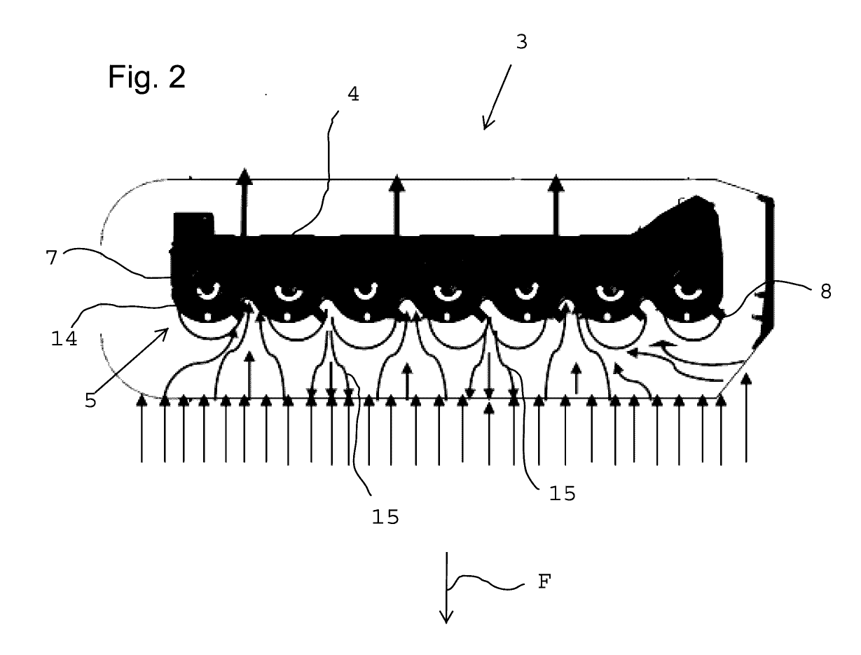

FIG. 2 shows a schematic view of a mower component group 3 in which the cutting members 5 which are embodied as mowing discs 7 are rotatably supported above the mowing beam 4. According to the arrows 14 indicating the rotational direction, the mowing discs 7 rotate mostly in opposite rotational directions and generate in this way air flows which are indicated by the flow arrows 15. Everywhere where two rotating neighboring mowing discs 7 are moving in the traveling and working direction F, an air flow results which acts on the stem or leaf crop still to be mowed in such a way that the crop is bent over upon mowing so that thereby the undesirable strip pattern is generated on the field or meadow.

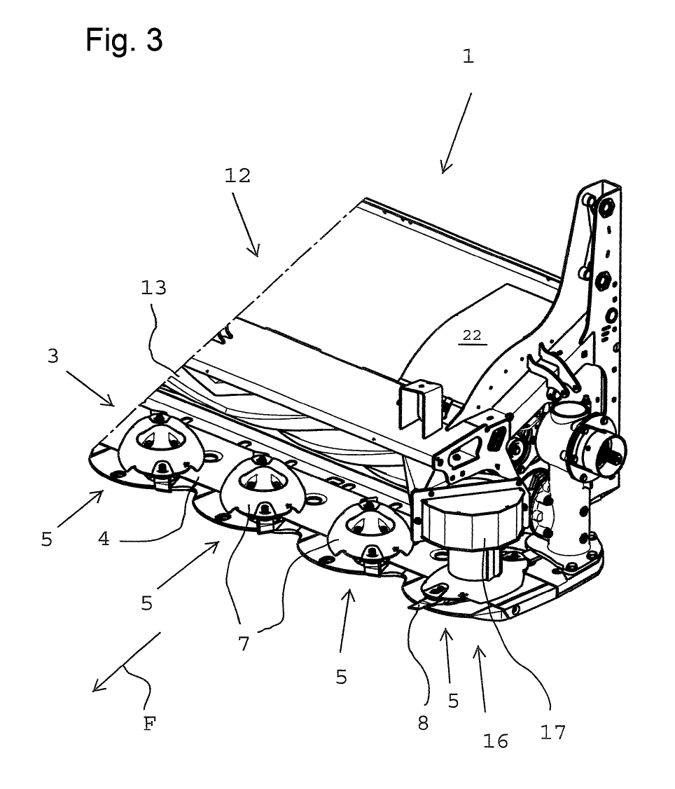

In FIG. 3, the mowing machine 1 is illustrated in more detail in a partially broken-off illustration wherein, for reasons of improved clarity of the drawing, the apron arrangement 10 and the protective hood 11 are omitted. It is clearly visible here that the mower component group 3 has correlated therewith an active suction or vacuum unit 16. Due to the suction action removing a sufficiently large air quantity from the surrounding area of the mower component group 3 from below the protection and cover component group 9, it is ensured in accordance with the invention that the undesirable air flow (see arrow 15 in FIG. 2) which is directed in the first direction toward the stem or leaf crop still to be mowed is deflected in a second direction in which the air flow is no longer acting on the stem or leaf crop still to be mowed.

In a particularly advantageous embodiment, the active suction and vacuum unit 16 is embodied as a fan or blower unit 17 with radial flow direction and sucks in, at the side which is facing the ground, the sufficiently large air quantity and discharges the air quantity subsequently into areas outside of the protection and cover component group 9.

As can be seen in particular in FIG. 3, the discharge of the air quantity that has been removed from the surrounding area of the mower component group 3 is realized here by means of an air passage 22 in an area downstream of the processing unit 12 so that the sucked away air quantity can serve here to improve the laying action of the stem or leaf crop onto the field or meadow.

In a further advantageous embodiment, it may be provided that the mower component group 3 has correlated therewith several fan or blower units 17. In particular, it can be advantageous when the mowing machine 1 at the left and right outer sides, viewed in the traveling and working direction F, is provided with a fan or blower unit 17 according to the invention.

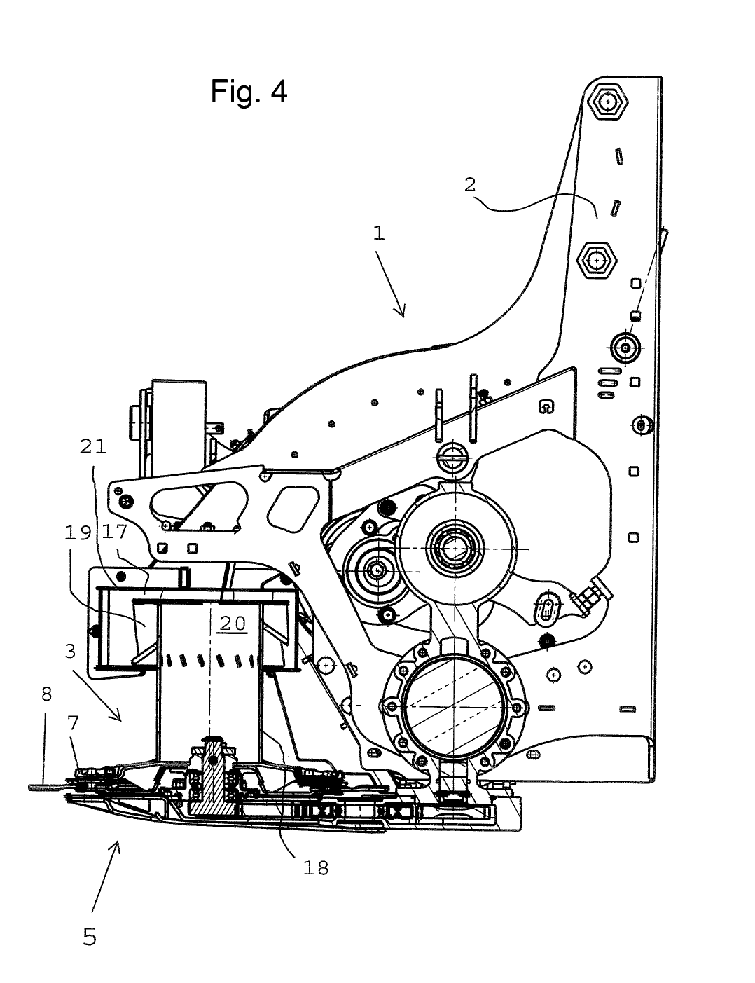

In FIG. 4, in a detail illustration the configuration and drive connection of a fan or blower unit 17 is illustrated. Beginning at the mowing disc 7 of a cutting member 5, above the mowing disc 7 a conveying and guiding drum 18 is extending and, at the top side area thereof, a fan or blower rotor 20 is provided that comprises conveying elements 19. The fan or blower rotor 20 is driven in rotation in a fan or blower housing 21. By means of the drive that is already provided at the mower component group 3 for the cutting members 5, the fan or blower unit 17 is supplied with drive energy.

The specification incorporates by reference the entire disclosure of German priority document 10 2015 006 065.1 having a filing date of May 15, 2015.

While specific embodiments of the invention have been shown and described in detail to illustrate the inventive principles, it will be understood that the invention may be embodied otherwise without departing from such principles.

What is claimed is:

1. A mowing machine for mowing agricultural stem and leaf crop, the mowing machine comprising:
a frame component group;
a mower component group connected to the frame component group, wherein the frame component group supports the mower component group in a working and operating position on a ground surface of a field or meadow to be mowed;
a protection and cover component group arranged on the mower component group and at least partially surrounding the mower component group;
the mower component group comprising at least two cutting members driven in rotation about an approximately vertically oriented axis, respectively;
the cutting members arranged in a transverse direction relative to a traveling and working direction of the mowing machine across the ground surface;
the cutting members each comprising at least one rotation body that, in the working and operating position, is close to the ground surface and that comprises an outer periphery provided with at least two cutting blades;
an active suction unit correlated with the mower component group, wherein the active suction unit is configured to deflect an air flow, which is oriented from the mower component group in a first direction toward the still standing stem and leaf crop, in a second direction in which the still standing stem and leaf crop is no longer loaded by the air flow.

2. The mowing machine according to claim 1, wherein the active suction unit is configured to deflect the air flow that is oriented in the first direction and occurs below the protection and cover component group and is caused by a rotation of the rotation bodies of the cutting members.

3. The mowing machine according to claim 1, further comprising a processing device arranged downstream of the mower component group and comprising at least one processing roller configured to process the stem and leaf crop.

4. The mowing machine according to claim 3, wherein the active suction unit is configured to deflect the air flow that is oriented in the first direction and occurs below the protection and cover component group and is caused by a rotation of the rotation bodies of the cutting members and/or by a rotation of the at least processing roller.

5. The mowing machine according to claim 3, wherein the active suction unit is configured to discharge the air flow that occurs below the protection and cover component group to an area downstream of the processing device for enhancing a laying action of the stem and leaf crop onto the ground surface.

6. The mowing machine according to claim 1, wherein the active suction unit is configured to discharge the air flow that occurs below the protection and cover component group to an area outside of the protection and cover component group.

7. The mowing machine according to claim 1, wherein the active suction unit is a fan or blower unit and is correlated with at least one of the cutting members.

8. The mowing machine according to claim 7, wherein the fan or blower unit is configured to have a radial flow direction.

9. The mowing machine according to claim 8, wherein one of the cutting members supplies the fan or blower unit with drive energy.

10. The mowing machine according to claim 8, wherein the fan or blower unit comprises a fan or blower rotor and further comprises a fan or blower housing, wherein the fan or blower rotor is provided with conveying elements, wherein the fan or blower rotor is mounted on a top side of one of the cutting members, wherein the fan or blower housing covers the fan or blower rotor and is secured on the frame component group or is secured on the protection and cover component group.

11. The mowing machine according to claim 8, wherein the fan or blower unit is correlated at least with two outwardly positioned cutting members of the mower component group.

12. The mowing machine according to claim 1, wherein the active suction unit is configured as a fan or blower unit with an axial flow direction.

13. The mowing machine according to claim 1, wherein the active suction unit is configured as a fan or blower unit comprising at least one fan or blower rotor comprising a length extension and arranged such that the length extension is positioned horizontally and transverse to the traveling and working direction, wherein the at least one fan or blower rotor is arranged above the cutting members, wherein the length extension of the at least one fan or blower rotor extends across several of the cutting members.

14. The mowing machine according to claim 1, wherein the active suction unit is configured such that large quantities of air can be discharged from the area below the protection and cover component group.

15. The mowing machine according to claim 14, wherein the active suction unit is configured to adjust the air quantity to be discharged.
